(19) United States
(12) Patent Application Publication
(10) Pub. No.: US 2021/0168426 A1
(43) Pub. Date: Jun. 3, 2021

(54) TRANSMITTING METHOD, RECEIVING METHOD, TRANSMITTING DEVICE, AND RECEIVING DEVICE

(71) Applicant: SHENZHEN LENKENG TECHNOLOGY CO., LTD, SHENZHEN (CN)

(72) Inventor: BINGHAI GAO, SHENZHEN (CN)

(21) Appl. No.: 17/082,050

(22) Filed: Oct. 28, 2020

(30) Foreign Application Priority Data
Nov. 28, 2019 (CN) 201911188994.3

(51) Int. Cl. H04N 21/426; H04N 21/4363; H04N 21/438; H04L 29/06

(52) U.S. Cl. CPC H04N 21/426; H04L 69/04; H04N 21/4382; H04N 21/43637

(57) ABSTRACT

Provided are a transmitting method, a receiving method, a transmitting device, and a receiving device. The transmitting method includes: obtaining, by a transmitting device, multimedia data, encoding, by the transmitting device, the multimedia data with a compression algorithm to obtain code stream data, encapsulating, by the transmitting device, the code stream data into a protocol data stream, modulating, by a first modem of the transmitting device, the protocol data stream, and transmitting, by the transmitting device, a modulated signal to a receiving device based on a millimeter wave communication technology of a 60 GHz frequency band. By adopting the disclosure, lossless compression of video data can be achieved, and a high-definition display connected with the receiving device can play visually lossless high-definition videos without delay while transmission costs are reduced.

### CROSS REFERENCE TO RELATED APPLICATIONS

The present application claims priority to Chinese Patent Application Serial No. 201911188994.3 on Nov. 28, 2019, the disclosure of which is hereby incorporated by reference.

### TECHNICAL FIELD

The disclosure relates to the field of network communication technologies, and in particular to a transmitting method, a receiving method, a transmitting device, and a receiving device.

### BACKGROUND

At present, a display technology develops rapidly, and bandwidth requirements of a display link increase proportionally with the improvement of a display resolution. However, some display links cannot meet bandwidth requirements of a high-definition display.

In the prior art, the existing video is transmitted over extended distances by using links, but the quality of the video transmitted to the high-definition display has a certain loss. In addition, when the received video is played by using the high-definition display, the visual delay is longer.

### SUMMARY

Based on the foregoing problems and disadvantages of the prior art, a transmitting method, a receiving method, a transmitting device, and a receiving device are provided. On one hand, a display device coupled with the receiving device can play a visually lossless high-definition video without delay; on the other hand, data transmission costs can be reduced.

According to a first aspect, a transmitting method is provided. The method includes the following. A transmitting device obtains multimedia data, encodes the multimedia data with a compression algorithm to obtain code stream data, encapsulates the code stream data into a protocol data stream, modulates, by a first modem of the transmitting device, the protocol data stream, and transmits a modulated signal to a receiving device based on a millimeter wave communication technology of a 60 GHz frequency band.

According to a second aspect, a receiving method is provided. The method includes the following: a receiving device receives a modulated signal from a transmitting device, and demodulates, by a second modem of the receiving device, the modulated signal to obtain a specific protocol data stream. The receiving device decapsulates the specific protocol data stream to obtain specific code stream data, and decodes the specific code stream data with a decompression algorithm to obtain specific multimedia data.

According to a third aspect, a transmitting device is provided. The transmitting device includes a first memory and a first processor connected with the first memory, where the first memory is configured to store first application program codes, and the first processor is configured to call the first application program codes to perform the following: obtaining multimedia data; encoding the multimedia data with a compression algorithm to obtain code stream data, encapsulating the code stream data into a protocol data stream, modulating the protocol data stream with a first modem, and transmitting a modulated signal to a receiving device based on the millimeter wave communication technology of the 60 GHz frequency band.

According to a fourth aspect, a receiving device is provided. The receiving device includes a second memory and a second processor connected with the second memory, where the second memory is configured to store second application program codes, and the second processor is configured to call the second application program codes to perform the following: demodulating, by a second modem, the modulated signal from the transmitting device to obtain a specific protocol data stream, decapsulating the specific protocol data stream to obtain specific code stream data, and decoding the specific code stream data with a decompression algorithm to obtain specific multimedia data.

The transmitting method, the receiving method, the transmitting device, and the receiving device are provided in the disclosure. The multimedia data can be compressed by encoding multimedia data into code stream data with a compression algorithm. The transmission bandwidth can be reduced, and transmission costs can be reduced to a certain extent. The code stream data is encapsulated into a protocol data stream, and the protocol data stream is modulated to obtain the modulated signal transmitted to the receiving device with the millimeter wave communication technology of the 60 GHz frequency band. In the transmission process, the multimedia data is subjected to less interference, and the 60 GHz frequency band can support the higher transmission bandwidth. In summary, the high-definition display connected with the receiving device can play the visually lossless high-definition video without delay, and the user experience is better.

### BRIEF DESCRIPTION OF THE DRAWINGS

In order to describe technical solutions in implementations of the disclosure more clearly, the drawings used in the description of the implementations are briefly introduced below. Obviously, the drawings in the following description are some implementations of the disclosure. For ordinary technicians, other drawings can be obtained based on these drawings without paying creative work.

FIG. 1 is a schematic flow chart of a transmitting method according to the disclosure.

FIG. 2 is a schematic flow chart of a receiving method according to the disclosure.

FIG. 3 is a schematic diagram of an application scenario according to the disclosure.

FIG. 4 is a schematic diagram of another application scenario according to the disclosure.

FIG. 5 is a schematic diagram of another application scenario according to the disclosure.

FIG. 6 is a schematic diagram of another application scenario according to the disclosure.

FIG. 7 is a schematic structural diagram of a transmitting device according to the disclosure.

FIG. 8 is a schematic structural diagram of a receiving device according to the disclosure.

FIG. 9 is a schematic structural diagram of a system according to the disclosure.

FIG. 10 is a schematic structural diagram of another system according to the disclosure.

### DETAILED DESCRIPTION OF THE PREFERRED EMBODIMENTS

The technical solutions in the disclosure will be described clearly and completely in combination with the accompanying drawings in the disclosure. Obviously, the described implementations are part of the implementations of the disclosure, but not all of the disclosure. All other implementations obtained by those of ordinary skill in the art based on the disclosure without creative efforts shall fall within the protection scope of the disclosure.

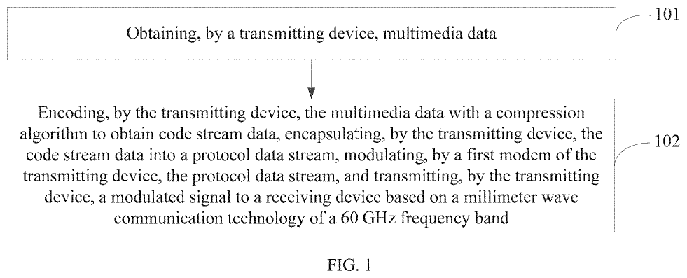

FIG. 1 is a schematic flow chart of a transmitting method according to the disclosure. As shown in FIG. 1, the method may include, but is not limited to, the following.

At block 101, a transmitting device obtains multimedia data.

The multimedia data may include, but is not limited to, perception media data such as text, data, sound, graphics, images, or videos (such as 1080P, 4K or 8K resolution, high-definition video with frame rate 60 FPS), representation media data such as telegram code or bar code etc. It should be noted that the multimedia data includes one or more different types of video source data (such as surveillance video, promotional video, cartoon, costume drama or modem urban drama), which are not limited in implementations of the disclosure.

At block 102, the transmitting device encodes the multimedia data with a compression algorithm to obtain code stream data, encapsulates the code stream data into a protocol data stream according to different protocols, modulates, by a first modem of the transmitting device, the protocol data stream to obtain a modulated signal, and transmits the modulated signal to a receiving device based on a millimeter wave communication technology of a 60 GHz frequency band, where the 60 GHz frequency band can support a higher transmission bandwidth, so the transmitting device can transmit the protocol data stream to the receiving device by the millimeter wave communication technology of the 60 GHz frequency band, so that a display device coupled with the receiving device can display a high-definition video without delay and without loss of quality.

In the implementations of the disclosure, the protocol data stream may include, but is not limited to, the following.

First type of protocol data stream: protocol data stream in the form of a transmission-minimized differential signaling (TMDS). It should be noted that the protocol data stream in the form of the TMDS can be obtained by encapsulating the code stream data by the transmitting device according to a TMDS protocol.

Second type of protocol data stream: protocol data stream in the form of a datagram.

According to implementations of the disclosure, the datagram may include a datagram defined by the TCP/IP protocol and capable of being transmitted on the Internet, such as an IP datagram, an user datagram protocol (UDP) datagram, and an iBeacan datagram. The IP datagram can be composed of a header and data. It should be noted that an earlier part of the header includes a fixed length of 20 bytes, and configured to store a source address (such as an IP protocol address) and a destination address.

It should be noted that the protocol data stream in the form of the UDP datagram can be obtained through encapsulating, according to the UDP protocol, the code stream data by the transmitting device, and the protocol data stream in the form of the P datagram can be obtained through encapsulating, according to the IP protocol, the code stream data by the transmitting device.

It should be noted that the transmitting device encodes the multimedia data with a compression algorithm to obtain code stream data, which may include, but is not limited to, the following.

Method 1: the transmitting device encodes the multimedia data with a display stream compression (DSC) algorithm to obtain the code stream data.

Method 2: the transmitting device encodes multimedia data with a color space converter (CSC) to obtain first data, and encode the first data with the DSC algorithm to obtain the code stream data.

Method 3: the transmitting device encodes multimedia data with a JPEG2000 algorithm to obtain the code stream data.

Method 4: the transmitting device encodes the multimedia data with a Huffman algorithm to obtain the code stream data.

The following takes the use of the DSC algorithm to encode the multimedia data to obtain code stream data as an example to describe a transmitting method for multimedia data in detail.

Taking the multimedia data being a video as an example, the video is encoded with the DSC algorithm, which may specifically include, but is not limited to, the following.

At step 1, the transmitting device divides each frame image of the video into several non-overlapping square bars as independent encoding units. The coding is performed on a line scanning manner. A×1 pixel groups composed of A pixel can be a processing unit, where any one of A pixel is connected. Optionally, A can be 3, 4, or 5, which is not limited herein.

At step 2, the transmitting device uses the DSC algorithm to predict the current pixel based on the intra-differential pulse code modulation (DPCM) method. The prediction residual value is quantized and reconstructed by using a simple integer power quantization of 2. The quantized residual signal is subjected to entropy coding (such as Variable Length Coding (VLC)), where the entropy coding operates on a 3×1 pixel group, and each component can generate an entropy-coded sub-code stream. These sub-code streams (that is, each sub-code stream may be a compressed data stream formed by each component) are packed, stream-multiplexed, and outputted. It should be noted that the DSC algorithm can support, but is not limited to, the following prediction modes: modified median adaptive prediction (MMAP), block prediction (BP), and mid-point prediction (MPP).

It should be noted that the transmitting device transmits media data with 4K resolution and 60 frames per second, and the required transmission bandwidth is required approximately 18 Gbit/s. If the transmitting device compresses the media data with twice, then the transmission bandwidth required for transmitting the media data can be half of the original bandwidth (9 Gbit/s), so the transmission data being compressed can greatly reduce the transmission bandwidth, which correspondingly reduce the transmission cost.

It should be understood that the transmitting device may further encode the multimedia data with the CSC to obtain code stream data.

The transmitting device converts code stream data with a YUV444 format into code stream data with a YUV422 format through the CSC, so that the data amount of the code stream data with the YUV422 format is ⅔ of the data amount of the code stream data with the YUV444 format into code stream data.

It should be noted that data with the YUV444 format indicates that each Y component corresponds to a set of UV components, and data with the YUV422 format indicates that every two Y components correspond to (share) a set of UV components. In summary, by converting the data with the YUV444 format into the data with the YUV422 format, the data amount of the data with YUV422 format is ⅔ of the data amount of the data with the YUV444 format.

It should be noted that data with the YUV422 format indicates that every two Y components correspond to (share) a set of UV components, and data with a YUV420 format indicates that every four Y components can correspond to (share) a set of UV components. In summary, the transmitting device converts the data with the YUV422 format into the data with the YUV420 format, which can make the data amount of the data with the YUV420 format is ¾ of the data with the YUV422 format.

It should be understood that the transmitting device can further encode the multimedia data with the JPEG2000 algorithm to obtain code stream data.

Specifically, the transmitting device firstly perform, through the JPEG2000 algorithm, discrete wavelet transform on multimedia data to obtain transformed wavelet coefficients, quantize the transformed wavelet coefficients to obtain quantized data, perform entropy encoding on the quantized data to obtain the code stream data, and finally output the code stream data. The object processed through the JPEG2000 algorithm by the transmitting device is not the whole image, but image slices decomposed from the whole image, where each image slice is subjected to independent encoding and decoding operations. The JPEG2000 algorithm mainly adopts the discrete wavelet transform algorithm, which can achieve lossless compression of images to obtain compressed images, and the compressed images are more exquisite and smoother. In summary, the transmitting device can encode the multimedia data according to any one of the foregoing methods to obtain code stream data, or the multimedia data can be encoded according to any two or more of the foregoing methods to obtain code stream data.

When a data format of the multimedia data is a RGB format, the transmitting device converts, through the CSC, the multimedia data with the RGB format into the multimedia data with a YUV444 format, samples the multimedia data with the YUV444 format to obtain the first data with the YUV format, and encodes, through the DSC, the first data to obtain the code stream data.

When a format of the multimedia data is the RGB format, the transmitting device converts, through the CSC, the multimedia data with the RGB format into the multimedia data with the YUV444 data format, samples the multimedia data with the YUV444 format of to obtain the first data with the YUV format, and encodes, through the JPEG2000 algorithm, the first data to obtain the code stream data.

Specifically, assuming that the multimedia data is the data with format of YUV444, the data with format of YUV444 is first converted into data with a format of YUV422 through the CSC. Then, the data with the format of YUV422 is further encoded through the DSC to obtain code stream data.

It should be noted that the multimedia data is encoded with the DSC algorithm and the CSC to realize the shallow compression of the multimedia data, and in combination with the millimeter wave communication technology of the 60 GHz frequency band, a display device coupled with the receiving device can display a high-definition video without delay and without loss of quality. It should be noted that the 60 GHz frequency band can support a higher transmission bandwidth because it can support transmission of shallowly compressed protocol data streams (transmission of shallowly compressed video data requires a higher transmission bandwidth to ensure that the display device can display the video data without delay).

Alternatively, assuming that the multimedia data is the data with the YUV444 format, the data with the YUV444 format is first converted into data with the YUV422 format through the CSC. Then, the data with the YUV422 format is further compressed through the JPEG2000 algorithm to obtain code stream data.

It should be noted that the multimedia data is encoded with the JPEG2000 algorithm and the CSC, which realizes lossy compression of multimedia data. A compression degree is relatively high, and the receiving device has limited ability to recover the compressed data, which may slightly affect the quality of videos displayed by the display device connected with the receiving device. according to implementations of the disclosure, the transmitting device encapsulates the code stream data into a protocol data stream, modulates, by a first modem of the transmitting device, the protocol data stream to obtain a modulated signal, and transmits the modulated signal to the receiving device based on the millimeter wave communication technology of the 60 GHz frequency band. Specifically, the following methods may be included.

Method 1: the transmitting device encapsulates the code stream data into a protocol data stream in the form of TMDS by the TMDS technology, then the protocol data stream (such as low-frequency signals) in the form of TMDS is loaded to a plurality of mutually orthogonal subcarriers (such as high-frequency signals) by the first modem combined with orthogonal frequency division multiplexing (OFDM) technology, and the plurality of mutually orthogonal subcarriers loaded with the protocol data stream in the form of TMDS are transmitted to the receiving device by a first RF transceiver based on a millimeter wave communication technology of a 60 GHz frequency band.

It should be noted that the loading of the protocol data stream in the form of TMDS onto the plurality of mutually orthogonal subcarriers (such as high-frequency signals) may include three modes: frequency modulation, amplitude modulation and phase modulation.

It should be noted that the carrier is a radio wave of a specific frequency. The frequency of the subcarrier that can be used to carry the protocol data stream is located on about the 60 GHz frequency band. It should be noted that a wireless communication technology in which the communication carrier is on the 60 GHz frequency band belongs to a millimeter wave communication technology.

Method 2: the transmitting device encapsulates the code stream data into a protocol data stream in the form of the IP datagram, the protocol data stream in the form of the IP datagram is loaded to a plurality of mutually orthogonal subcarriers by the first modem combined with the OFDM technology to obtain preset data, and the preset data is transmitted to the receiving device though the millimeter wave communication technology of the 60 GHz frequency band.

Method 3: the transmitting device encapsulates the code stream data into a protocol data stream in the form of the UDP datagram, the protocol data stream in the form of the UDP datagram is loaded to a plurality of mutually orthogonal subcarriers by the first modem combined with the OFDM technology to obtain preset data, and the preset data is transmitted to the receiving device through the millimeter wave communication technology of the 60 GHz frequency band.

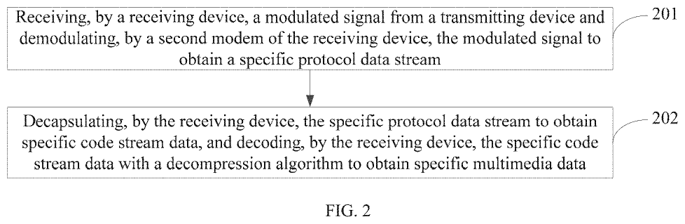

FIG. 2 is a schematic flow chart of a receiving method according to the disclosure. As shown in FIG. 2, the method may include, but is not limited to, the following.

At block 201, a receiving device receives a modulated signal from a transmitting device and demodulates, by a second modem of the receiving device, the modulated signal to obtain a specific protocol data stream.

Specifically, the receiving device recovers, by the second modem, the specific protocol data stream (such as a low-frequency signal) from the modulated signal received (such as a high-frequency signal).

It should be noted that the process that the receiving device recovering, by the second modem, the specific protocol data stream from the modulated signal received is inverse to the process that the transmitting device encapsulating the code stream data into a protocol data stream and modulating the protocol data stream to obtain the modulated signal.

At block 202, the receiving device decapsulates the specific protocol data stream to obtain specific code stream data, and decodes the specific code stream data with a decompression algorithm to obtain specific multimedia data.

In some implementations, the receiving device decapsulates the specific protocol data stream to obtain specific code stream data, which may specifically include, but is not limited to, the following processing methods.

Processing method 1: the specific protocol data stream in the form of the IP datagram can be decapsulated to obtain specific code stream data.

Processing method 2: the specific protocol data stream in the form of the UDP datagram can be decapsulated to obtain specific code stream data.

Processing method 3: the specific protocol data stream in the form of the TMDS can be decapsulated to obtain specific code stream data.

It should be noted that the process that the receiving device decapsulating the specific protocol data stream to obtain specific code stream data may be inverse to the process that the transmitting device encapsulating the code stream data into the protocol data stream.

If the transmitting device encodes the multimedia data with the DSC algorithm to obtain code stream data, the receiving device can decode the specific code stream data with a DSC decoding algorithm to obtain specific multimedia data.

If the transmitting device encodes the multimedia data with the JPEG2000 algorithm to obtain code stream data, the receiving device can decode the specific code stream data with the JPEG2000 algorithm to obtain specific multimedia data.

If the transmitting device convert the multimedia data with the CSC to obtain code stream data, the receiving device can decode the specific code stream data with the CSC to obtain specific multimedia data.

When a format of the specific multimedia data is a RGB format, the receiving device decodes, through the DSC decoding algorithm, the specific stream data to obtain first specific data with a YUV format, interpolates the first specific data to obtain the specific multimedia data with a YUV444 data format, and converts, through the CSC, the specific multimedia data with the YUV444 format into the specific multimedia data with the RGB format.

When a format of the specific multimedia data is a RGB format, the receiving device decodes, through the JPEG2000 decoding algorithm, the specific stream data to obtain first specific data with a YUV format, interpolates the first specific data to obtain the specific multimedia data with a YUV444 data format, and converts, with the CSC, the specific multimedia data with the YUV444 format into the specific multimedia data with the RGB format.

Taking the DSC algorithm as an example, the following simply explains how to decode the specific code stream data to obtain specific multimedia data.

Specifically, after the receiving device buffers the specific code stream data, the receiving device can extract residual, coding scheme and other information from a component code stream through variable length decoding (VLD), extract a predicted value from the coding scheme, inversely quantize the residual, and add the residual to the predicted value to obtain a group of pixel values of a reconstructed image so as to generate data (specific multimedia data) of the image frame.

In some implementations, four application scenarios of the foregoing receiving method are briefly described below.

Scenario 1: after the receiving device decodes the specific code stream data stream to obtain the specific multimedia data, the receiving device may also execute the following steps:

The receiving device outputs the specific multimedia data to a display device coupled with the receiving device, where the display device can be configured to display the specific multimedia data (for example, if the multimedia data inputted to the transmitting device has a 4K resolution and a rate of transmitting 60 image frames per second, the display device coupled with the receiving device can be configured to display the specific multimedia data with a 4K resolution and a rate of transmitting 60 image frames per second), and the display device may include, but is not limited to, a television, a display, a tablet computer, and the like.

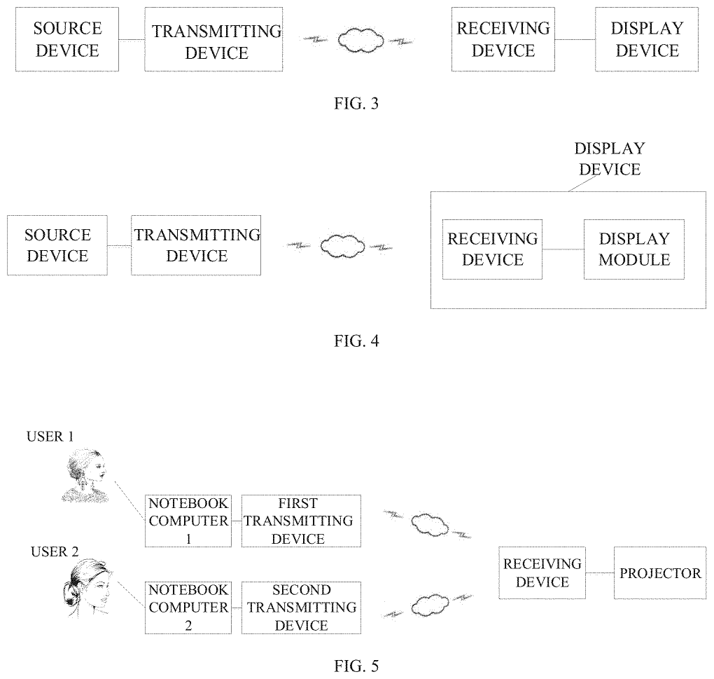

Scenario 1 is described below with reference to FIG. 3.

As shown in FIG. 3, the receiving device can output the multimedia data from a single video source device to a display connected with the receiving device, where the display is configured to display the multimedia data. It should be noted that data transmission can be performed, based on the millimeter wave communication technology of the 60 GHz frequency band, between the transmitting device and the receiving device shown in FIG. 3.

Scenario 2: the receiving device is integrated into the display device.

It should be noted that after the receiving device decodes the specific code stream data to obtain the specific multimedia data, the receiving device may also execute the following steps:

If the receiving device is integrated into the display device, the receiving device outputs the specific multimedia data to a display module of the display device, where the display module may be configured to display the specific multimedia data.

Scenario 2 is described below with reference to FIG. 4.

As shown in FIG. 4, the receiving device can output the multimedia data from a single video source device to a display module, and the receiving device can display the multimedia data by the display module. It should be noted that data transmission can be performed, based on the millimeter wave communication technology of the 60 GHz frequency band, between the transmitting device and the receiving device shown in FIG. 4.

Scenario 3: the transmitting device may include, but is not limited to, a first transmitting device and a second transmitting device.

Before the receiving device receives the modulated signal from the transmitting device, the receiving device receives a first protocol data stream (such as protocol data streams in the form of the iBeacan datagram) broadcasted from the first transmitting device and receives a second protocol data stream broadcasted from the second transmitting device, where the first protocol data stream includes an address of the first transmitting device, and the second protocol data stream includes an address of the second transmitting device.

Furthermore, the receiving device parses the first protocol data stream to obtain the address of the first transmitting device, parses the second protocol data stream to obtain the address of the second transmitting device, and stores the address of the first transmitting device and the address of the second transmitting device in a database.

Then, the receiving device parses a third protocol data stream from the first transmitting device to obtain the address of the first transmitting device when the receiving device receives the third protocol data stream for requesting the receiving device to establish a connection with the first transmitting device, where the third protocol data stream includes the address of the first transmitting device.

Finally, the receiving device determines whether there is the address of the first transmitting device in the database, upon determining that there is the address of the first transmitting device in the database, the receiving device establishes a connection with the first transmitting device and transmits confirmation information to the first transmitting device, where the confirmation information may be used for representing that the receiving device has established the connection with the first transmitting device.

The following shows an example to simply illustrate the scenario 3 described above (such as a meeting scenario).

Scenario 3 is described below with reference to FIG. 5.

As shown in FIG. 5, a user 1 is provided with a notebook computer 1 and a user 2 is provided with a notebook computer 2, where the notebook computer 1 is connected with the first transmitting device via an HDMI interface of the first transmitting device, the notebook computer 2 is connected with the second transmitting device via an HDMI interface of the second transmitting device, the first transmitting device and the second transmitting device are respectively communicatively connected with a receiving device, and the receiving device is connected with a display device.

The following briefly describes how to enable the user 1 to quickly demonstrate video source data stored in the notebook computer 1 by a projector connected with the receiving device, after the user 2 (such as a speaker) demonstrates video source data stored in the notebook computer 2 by the display device coupled with the receiving device.

The above processes are as follows.

Process 1: the first transmitting device receives an instruction inputted from the user 1.

Process 2: in response to the instruction inputted from the user 1, the first transmitting device transmits a second protocol data stream to a receiving device, where the second protocol data stream is used for requesting the first transmitting device to establish a connection with the receiving device, and the second protocol data stream includes the address of the first transmitting device.

Process 3: the receiving device parses the second protocol data stream to obtain the address of the first transmitting device, when the receiving device receives the second protocol data stream for requesting the first transmitting device to establish a connection with the receiving device, where the second protocol data stream includes the address of the first transmitting device.

Process 4: the receiving device determines whether there is the address of the first transmitting device in the database of the receiving device, upon determining that there is the address of the first transmitting device in the database, the receiving device establishes a connection with the first transmitting device, and the receiving device transmits confirmation information to the first transmitting device, where the confirmation information is used for representing that the receiving device has established the connection with the first transmitting device.

Before the first transmitting device transmits the second protocol data stream for requesting the first transmitting device to establish a connection with the receiving device, where the second protocol data stream includes the address of the first transmitting device, the receiving device separately receives the first protocol data stream broadcasted from the first transmitting device and the second transmitting device, parses the first protocol data stream to obtain parsed addresses, and stores the parsed addresses in the database, where the first protocol data streams include the address of the first transmitting device and the address of the second transmitting device.

If there is the address of the first transmitting device in the database, the receiving device establishes a connection with the first transmitting device, which may include the following steps:

If there is the address of the first transmitting device in the database, the receiving device switches from a communication channel between the receiving device and the transmitting device to a communication channel between the receiving device and the first transmitting device. The communication channel may be a physical communication channel (namely, a low-rate physical communication channel) with a 60 GHz frequency band such as 60.16 GHz, 60.48 GHz or 60.80 GHz, and the foregoing physical communication channels do not interfere with each other.

In the scenario 3, if the first transmitting device and the receiving device have established a connection, and the user 1 can display, by a projector connected with the receiving device, the video source data in the notebook computer 1 connected with the first transmitting device.

If the second transmitting device and the receiving device have established a connection, and the user 2 can display, by a projector connected with the receiving device, the video source data in the notebook computer 2 connected with the second transmitting device.

Scenario 4: a video source device includes a first video source device and a second video source device.

Before the transmitting device obtains the multimedia data, the transmitting device further executes the following steps.

At step 1, the transmitting device receives an infrared analog signal from a remote control by an infrared receiving head.

At step 2, the transmitting device demodulates the infrared analog signal to obtain an infrared digital signal.

At step 3, the transmitting device decodes the infrared digital signal to obtain a channel control code.

At step 4, the transmitting device determines a channel control instruction associated with the channel control code according to the channel control code.

At step 5, the transmitting device switches from an HDMI channel between the transmitting device and the video source device to an HDMI channel between the transmitting device and the first video source device according to the channel control instruction, where the HDMI channel between the transmitting device and the first video source device is used for obtaining, by the transmitting device, the multimedia data from the first video source device.

The following shows an example to simply illustrate the scenario 4 described above (such as a family scenario).

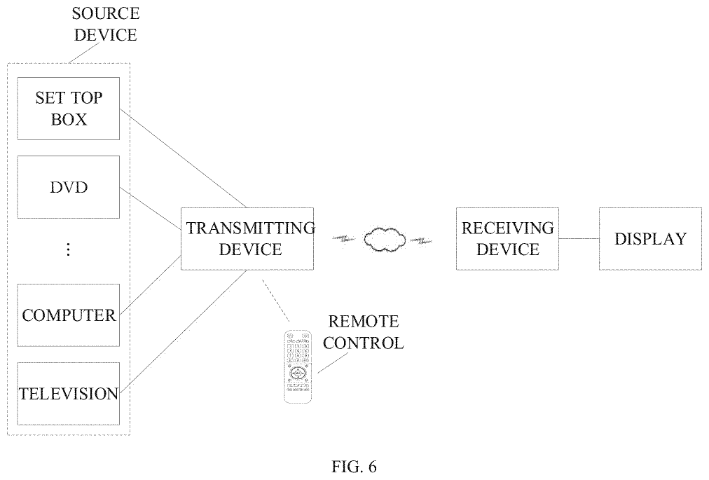

Scenario 4 is described below with reference to FIG. 6.

As shown in FIG. 6, the video source device may include, but is not limited to, a DVD, a set top box, a computer, a television, and the like.

The transmitting device can be respectively connected, via a plurality of HDMI interfaces configured on the transmitting device, with the video source device such as the DVD, the set top box, the computer and the television.

It should be noted that data transmission can be performed, based on the millimeter wave communication technology of the 60 GHz frequency band, between the transmitting device and the receiving device shown in FIG. 6.

The following briefly describes how to obtain video source data from a specific video source device among multiple video source devices and display the video source data by a display connected with the receiving device. Specifically, the method may include, but is not limited to, the following processes.

Process 1: a remote control receives a command inputted by a user.

Process 2: in response to the command, the remote control transmits an infrared analog signal to a transmitting device.

Process 3: the transmitting device receives the infrared analog signal from the remote control by an infrared receiving head, demodulates the received infrared analog signal to obtain an infrared digital signal, and decodes the infrared digital signal to obtain a channel control code.

Process 4: the transmitting device determines a channel control instruction associated with the channel control code according to the channel control code.

Process 5: the transmitting device switches from an HDMI channel between the transmitting device and the video source device to an HDMI channel between the transmitting device and the first video source device (such as a DVD) according to the channel control instruction, where the HDMI channel between the transmitting device and the first video source device is used for obtaining, by the transmitting device, the multimedia data from the first video source device.

It should be noted that FIG. 3 to FIG. 6 are only used to describe the implementations of the disclosure and should not limit the disclosure.

According to implementations of the disclosure, the transmitting device encodes multimedia data corresponding to 4K videos into code stream data with a compression algorithm to make the multimedia data being compressed, a transmission bandwidth being reduced, and transmission costs being reduced to a certain extent. The transmitting device encapsulates the code stream data into a protocol data stream, modulate the protocol data stream to obtain a modulated signal, and transmitting the modulated signal to a receiving device based on the millimeter wave communication technology of a 60 GHz frequency band. In the transmission process, the multimedia data is subjected to less interference, and the 60 GHz frequency band can support the higher transmission bandwidth. In summary, the high-definition display connected with the receiving device can play the visually lossless high-definition video without delay, and the user experience is better.

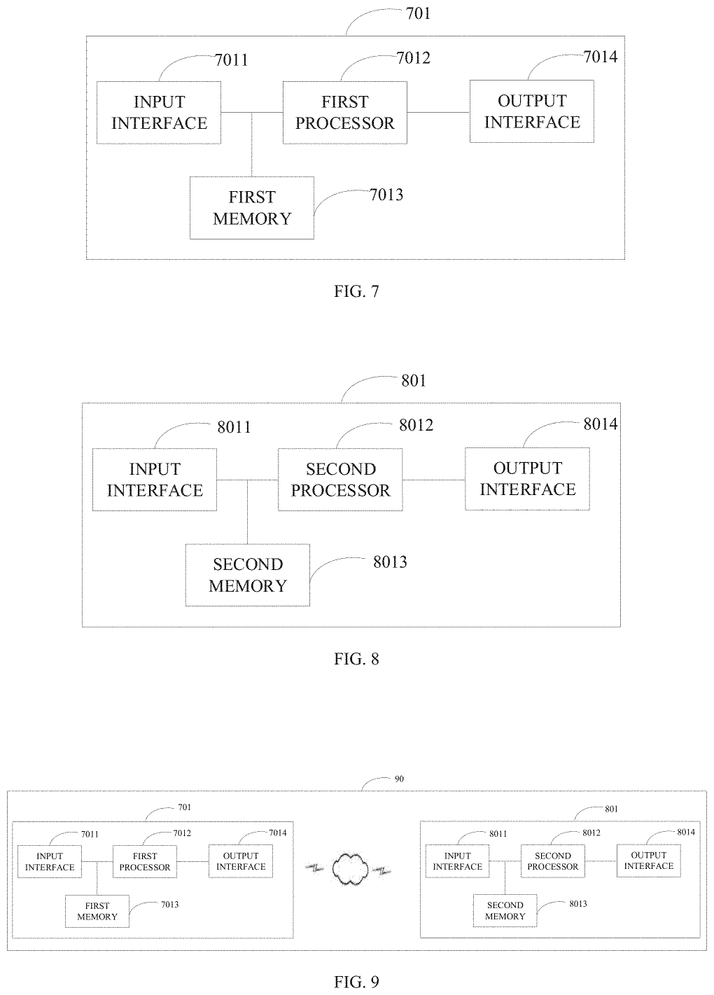

According to implementations of the disclosure, a device is provided. FIG. 7 is a schematic structural diagram illustrating a transmitting device according to implementations of the disclosure.

As shown in FIG. 7, the transmitting device 701 may include, but is not limited to, an input interface 7011, a first processor 7012, and a first memory 7013. The input interface 7011, the first processor 7012, the first memory 7013 and an output interface 7014 can communicate with each other via one or more communication buses.

It should be noted that the first memory 7013 is coupled with the first processor 7012, and the first memory 7013 can be configured to store multimedia data obtained by the transmitting device 701.

The input interface 7011 can be configured to enable the transmitting device 701 to obtain multimedia data from a video source device connected with the transmitting device 701.

It should be noted that the first processor 7012 includes a display stream compression (DSC) chip.

The first processor 7012 can be configured to encode the multimedia data with the DSC chip based on a compression algorithm to obtain code stream data, encapsulate the code stream data into a protocol data stream, and modulate, by a first modem of the transmitting device, the protocol data stream to obtain a modulated signal.

The output interface 7014 can be configured to output the modulated signal to other devices.

It should be understood that the first memory 7013 can be configured to store the multimedia data obtained from the video source device connected with the transmitting device 701, or store a program for processing the multimedia data.

It should be noted that the first memory 7013 may include a high-speed random access memory or a non-volatile memory, and can further store an operating system, a network communication program and a user interface program.

The first processor 7012 is specifically configured to encode the multimedia data with a DSC to obtain the code stream data.

The first processor 7012 is specifically configured to: when a data format of the multimedia data is a RGB format, convert the multimedia data with RGB format through a color space converter (CSC) into the multimedia with the YUV444 format, sample the multimedia with the YUV444 format to obtain first data with the YUV format; and encode the first data through a display stream compression (DSC) algorithm to obtain the code stream data.

A video source device is coupled with the transmitting device 701 and include a first video source device and a second video source device.

The transmitting device 701 further includes an infrared receiving head, where the infrared receiving head is configured to receive an infrared analog signal from a remote control.

Before the first processor 7012 is configured to obtain the multimedia data, the first processor 7012 is further configured to demodulate the infrared analog signal to obtain an infrared digital signal, decode the infrared digital signal to obtain a channel control code, determine a channel control instruction associated with the channel control code according to the channel control code, and switch an HDMI channel between the transmitting device 701 and the video source device to an HDMI channel between the transmitting device 701 and the first video source device according to the channel control instruction, where the HDMI channel between the transmitting device 701 and the first video source device is used for obtaining, by the transmitting device 701, the multimedia data from the first video source device.

It should be understood that the transmitting device 701 is only one example provided according to implementations of the disclosure, and the transmitting device 701 may have more or fewer components than above shown, may combine two or more components, or may be implemented with different configurations of components.

It is understood that specific implementations of the functional components included in the transmitting device 701 of FIG. 7 can be referred to the implementations of FIG. 1, which will not be repeated herein.

According to implementations of the disclosure, a receiving device is provided. FIG. 8 is a schematic structural diagram illustrating a receiving device according to implementations of the disclosure.

As shown in FIG. 8, the receiving device 801 may include, but is not limited to, an input interface 8011, a second processor 8012, and a second memory 8013. The input interface 8011, the second processor 8012, the second memory 8013 and an output interface 8014 can communicate with each other via one or more communication buses.

It should be noted that the input interface 8011 can be configured to enable the receiving device 801 to receive a modulated signal transmitted from other devices.

It should be noted that the second processor 8012 includes a display stream compression (DSC) chip; and the second processor 8012 can be configured to demodulate the modulated signal to obtain a specific protocol data stream, decapsulate the specific protocol data stream to obtain specific code stream data, and decode the specific code stream data with the DSC chip based on a decompression algorithm to obtain specific multimedia data.

The output interface 8014 can be configured to output the specific multimedia data to a display device coupled with the receiving device 801, and the display device is configured to display the specific multimedia data.

It should be noted that the second memory 8013 is coupled with the second processor 8012 and can be configured to store the modulated signal from other devices.

It is understood that the second memory 8013 can be configured to store the modulated signal from other devices, as well as programs for processing the modulated signal from other devices.

It should be noted that the second memory 8013 may include a high-speed random access memory. In addition, the second memory 8013 may store an operating system, a network communication program and a user interface program.

The second processor 8012 may be configured to decode the specific code stream data with a DSC to obtain the specific multimedia data.

The second processor 8012 may be configured to: when a format of the specific multimedia data is a RGB format, decode, through the DSC decoding algorithm, the specific stream data to obtain first specific data with a YUV format, interpolate the first specific data to obtain the specific multimedia data with a YUV444 data format, and convert, through a color space converter (CSC), the specific multimedia data with the YUV444 format into the specific multimedia data with the RGB format.

The transmitting device includes a first transmitting device and a second transmitting device.

The receiving device 801 further includes an input interface, and the input interface is configured to receive a first protocol data stream from the first transmitting device and a second protocol data stream from the second transmitting device, where the first protocol data stream comprises an address of the first transmitting device, and the second protocol data stream comprises an address of the second transmitting device.

The second processor 8012 is further configured to parse the first protocol data stream and second protocol data stream to obtain the address of the first transmitting device and the address of the second transmitting device respectively, store the address into a database, when the input interface is further configured to receive a third protocol data stream that is transmitted by the first transmitting device for requesting establishment of a connection with the receiving device and that carries the address of the first transmitting device, parse the third protocol data stream to obtain the address of the first transmitting device, and determine whether there is the address of the first transmitting device in the database. If there is the address of the first transmitting device in the database, the receiving device switches from a communication channel between the receiving device 801 and the transmitting device to a communication channel between the receiving device 801 and the first transmitting device.

The receiving device 801 further includes an output interface. The output interface is configured to output the specific multimedia data to a display device coupled with the receiving device, and the display device is configured to display the specific multimedia data.

When the receiving device 801 is integrated into a display device, the output interface is further configured to output the specific multimedia data to a display module of the display device, where the display module is configured to display the specific multimedia data.

It should be understood that the receiving device 801 is only one example provided according to implementations of the disclosure, and the receiving device 801 may have more or fewer components than above shown, may combine two or more components, or may be implemented with different configurations of components.

It is understood that specific implementations of the functional components included in the receiving device 801 of FIG. 8 can be referred to the implementations of FIG. 2, which will not be repeated herein.

According to implementations of the disclosure, a system is provided. The system can be configured to execute the method in the embodiment shown in FIG. 1. The system shown in FIG. 9 can be configured to execute the method in the foregoing implementations.

As shown in FIG. 9, a system 90 may include a transmitting device 701 and a receiving device 801, where the transmitting device 701 and the receiving device 801 can communicate with each other based on a millimeter wave communication technology of a 60 GHz frequency band.

The transmitting device 701 may include, but is not limited to, an input interface 7011, a first processor 7012, and a first memory 7013. The input interface 7011, the first processor 7012, the first memory 7013 and an output interface 7014 can communicate with each other via one or more communication buses.

It should be noted that the first memory 7013 is coupled with the first processor 7012, and the first memory 7013 can be configured to store multimedia data obtained by the transmitting device 701.

The input interface 7011 can be configured to enable the transmitting device 701 to obtain multimedia data from a video source device connected with the transmitting device 701.

The first processor 7012 can be configured to encode the multimedia data with a compression algorithm to obtain code stream data, encapsulate the code stream data into a protocol data stream, and modulate, by a first modem of the transmitting device, the protocol data stream to obtain a modulated signal.

The output interface 7014 can be configured to output the modulated signal to the receiving device 801.

The receiving device 801 may include, but is not limited to, an input interface 8011, a second processor 8012, and a second memory 8013. The input interface 8011, the second processor 8012, the second memory 8013 and an output interface 8014 can communicate with each other via one or more communication buses.

It should be noted that the input interface 8011 can be configured to enable the receiving device 801 to receive a modulated signal transmitted from the transmitting device 701.

The second processor 8012 can be configured to demodulate the received modulated signal to obtain a specific protocol data stream, decapsulate the specific protocol data stream to obtain specific code stream data, and decode the specific code stream data to obtain specific multimedia data.

The output interface 8014 can be configured to output the specific multimedia data to a display device coupled with the receiving device 801, and the display device is configured to display the specific multimedia data.

It should be noted that definitions or explanations not given according to implementations of the disclosure, can be referred to the implementations of FIG. 7 and FIG. 8. It is understood that specific implementations of the functional components included in the system 90 of FIG. 9 can be referred to the implementations of FIG. 1, FIG. 7 and FIG. 8, which will not be repeated herein.

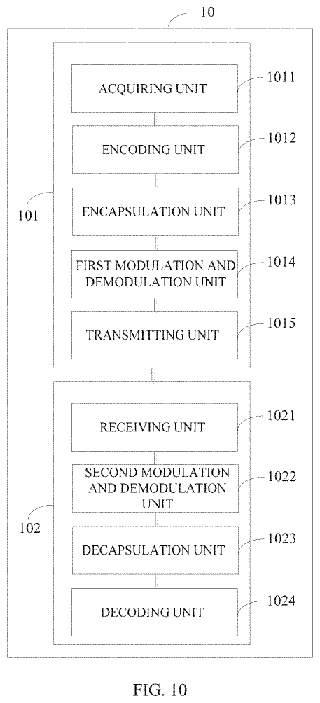

According to implementations of the disclosure, another system is provided. The system can be configured to execute the method in implementations of FIG. 1 and FIG. 2 respectively. The system shown in FIG. 10 can be configured to execute the method in the implementations of FIG. 1 and FIG. 2 respectively. As shown in FIG. 10, a system 10 may include a transmitting device 101 and a receiving device 102. It should be noted that the transmitting device 101 and the receiving device 102 can communicate with each other based on the millimeter wave communication technology of the 60 GHz frequency band.

The transmitting device 101 may include an acquiring unit 1011, an encoding unit 1012, an encapsulation unit 1013, a first modulation and demodulation unit 1014 and a transmitting unit 1015.

The acquiring unit 1011 is configured to obtain multimedia data.

The encoding unit 1012 is configured to encode the multimedia data with a compression algorithm to obtain code stream data.

The encapsulation unit 1013 is configured to encapsulate the code stream data into a protocol data stream.

The first modulation and demodulation unit 1014 is configured to modulate, by a first modem of the transmitting device, the protocol data stream.

The transmitting unit 1015 is configured to transmit a modulated signal to the receiving device 102 based on a millimeter wave communication technology of a 60 GHz frequency band.

The receiving device 102 may include a receiving unit 1021, a second modulation and demodulation unit 1022, a decapsulation unit 1023 and a decoding unit 1024.

The receiving unit 1021 is configured to receive the modulated signal transmitted by the transmitting unit 1015.

The second modulation and demodulation unit 1022 is configured to demodulate the modulated signal to obtain a specific protocol data stream.

The decapsulation unit 1023 is configured to decapsulate the specific protocol data stream to obtain specific code stream data.

The decoding unit 1024 is configured to decode the specific code stream data to obtain specific multimedia data. The specific multimedia data can be displayed by a display device coupled with the receiving device 102.

It should be understood that the system 10 is only one example provided according to implementations of the disclosure, and the system 10 may have more or fewer components than above shown, may combine two or more components, or may be implemented with different configurations of components.

It is understood that specific implementations of the functional components included in the system 10 of FIG. 10 can be referred to the implementations of FIG. 1 and FIG. 2, which will not be repeated herein.

According to implementations of the disclosure, a computer readable storage medium is provided. The computer readable storage medium stores a computer program that is executed by a processor.

The computer readable storage medium may be an internal storage unit of the device described in any of the above implementations, such as a hard disk or memory of the device. The computer readable storage medium may also be an external storage device of the device, such as a plug-in hard disk provided on the device, a smart media card (SMC), a secure digital (SD) card, and a flash card. Further, the computer readable storage medium may also include both an internal storage unit of the device and an external storage device. The computer readable storage medium is configured to store computer programs and other programs and data required by the device. The computer readable storage medium can also be configured to temporarily store data that has been outputted or is about to be outputted.

Those of ordinary skill in the art may realize that the modules and algorithm steps of each example described in the disclosure can be implemented by electronic hardware, computer software, or a combination thereof. In order to clearly explain the interchangeability of hardware and software, the composition and steps of each example have been described generally in terms of functions in the above description. Whether these functions are performed on hardware or software depends on the specific application and design constraints of the technical solution. Professional technicians can use different methods to implement the described functions for each specific application, but such implementations should not be considered to be beyond the scope of the disclosure.

Those skilled in the art can clearly understand that, for the convenience and brevity of the description, the specific working processes of the devices and modules described above can refer to the corresponding processes in the foregoing implementations of the method, and are not repeated herein.

implementations of the device described above are only schematic. For example, the division of the modules is only a logical function division. In actual implementations, there may be another division manner. For example, multiple modules or components may be combined or integrated into another device, or some features can be ignored or not be implemented. In addition, the displayed or discussed mutual coupling or direct coupling or communication connection may be indirect coupling or communication connection through some interfaces, equipment, devices or modules, and may also be electrical, mechanical or other forms of connection.

The modules described as separate components may or may not be physically separated, and the components displayed as modules may or may not be physical modules, may be located in one place, or may be distributed on multiple network modules. Some or all of the modules may be selected according to actual needs to achieve the objects of the solutions according to at least one implementation of the disclosure.

In addition, each functional module in each implementation of the disclosure may be integrated into one processing module, or each module may exist separately physically, or two or more modules may be integrated into one module. The above integrated modules may be implemented on the form of hardware or software functional modules.

When the integrated module is implemented on the form of a software functional module and sold or used as an independent product, it can be stored in a computer-readable storage medium. Based on this understanding, the technical solution of the disclosure essentially or a part that contributes to the existing technology, or all or part of the technical solution may be embodied on the form of a software product. The computer software product is stored in a storage medium which includes instructions to enable a computer device (which may be a personal computer, a server, or a network device, etc.) to perform all or part of the steps of the method described according to implementations of the disclosure. The foregoing storage media include: U-disks, mobile hard disks, read-only memory (ROM), random access memory (RAM), magnetic disks, or optical disks and other media that can store program codes.

The above is only a specific implementation of the disclosure, but the scope of protection of the disclosure is not limited to this. Any person skilled in the art can easily think of various equivalent modifications or replacements within the technical scope disclosed in the disclosure which should be covered by the protection scope of the disclosure. Therefore, the protection scope of the disclosure shall be subject to the protection scope of the claims.

1. A transmitting method, comprising:
obtaining, by a transmitting device, multimedia data;
encoding, by the transmitting device, the multimedia data with a compression algorithm to obtain code stream data;
encapsulating, by the transmitting device, the code stream data into a protocol data stream;
modulating, by a first modem of the transmitting device, the protocol data stream; and
transmitting, by the transmitting device, a modulated signal to a receiving device based on a millimeter wave communication technology of a 60 GHz frequency band.

2. The transmitting method of claim 1, wherein encoding, by the transmitting device, the multimedia data with the compression algorithm to obtain the code stream data comprises:
encoding, by the transmitting device, the multimedia data with a display stream compression (DSC) algorithm to obtain the code stream data.

3. The transmitting method of claim 1, wherein encoding, by the transmitting device, the multimedia data with the compression algorithm to obtain the code stream data comprises:
when a data format of the multimedia data is a RGB format,
converting, by the transmitting device, the multimedia data with RGB format through a color space converter (CSC) into the multimedia with the YUV444 format, sampling the multimedia with the YUV444 format to obtain first data with the YUV format; and
encoding, by the transmitting device, the first data through a DSC algorithm to obtain the code stream data.

4. The transmitting method of claim 1, wherein the transmitting device is coupled with a video source device, and the video source device comprises a first video source device and a second video source device, wherein the transmitting method further comprises the following:
before the obtaining, by the transmitting device, multimedia data,
receiving, by an infrared receiving head of the transmitting device, an infrared analog signal from a remote control;
demodulating, by the transmitting device, the infrared analog signal to obtain an infrared digital signal;
decoding, by the transmitting device, the infrared digital signal to obtain a channel control code;
determining, by the transmitting device, a channel control instruction associated with the channel control code according to the channel control code; and
switching, by the transmitting device, a high definition multimedia interface (HDMI) channel between the transmitting device and the video source device to an HDMI channel between the transmitting device and the first video source device according to the channel control instruction, wherein the HDMI channel between the transmitting device and the first video source device is used for obtaining, by the transmitting device, the multimedia data from the first video source device.

5. A receiving method, comprising:
receiving, by a receiving device, a modulated signal from a transmitting device and demodulating, by a second modem of the receiving device, the modulated signal to obtain a specific protocol data stream;
decapsulating, by the receiving device, the specific protocol data stream to obtain specific code stream data; and
decoding, by the receiving device, the specific code stream data with a decompression algorithm to obtain specific multimedia data.

6. The receiving method of claim 5, wherein decoding, by the receiving device, the specific code stream data with the decompression algorithm to obtain the specific multimedia data comprises:
decoding, by the receiving device, the specific code stream data with a display stream compression (DSC) decoding algorithm to obtain the specific multimedia data.

7. The receiving method of claim 5, wherein decoding, by the receiving device, the specific code stream data with the decompression algorithm to obtain the specific multimedia data comprises:
when a format of the specific multimedia data is a RGB format,
decoding, by the receiving device, the specific stream data to obtain first specific data with a YUV forma through the DSC decoding algorithm, interpolating the first specific data to obtain the specific multimedia data with a YUV444 data format, and converting, through a color space converter (CSC), the specific multimedia data with the YUV444 format into the specific multimedia data with the RGB format.

8. The receiving method of claim 5, wherein the transmitting device comprises a first transmitting device and a second transmitting device, and the receiving method further comprises the following:
before the receiving, by a receiving device, a modulated signal from a transmitting device,
receiving, by the receiving device, a first protocol data stream broadcast by the first transmitting device and receiving, by the receiving device, a second protocol data stream broadcast by the second transmitting device, wherein the first protocol data stream comprises an address of the first transmitting device, and the second protocol data stream comprises the address of the second transmitting device;
parsing, by the receiving device, the first protocol data stream to obtain the address of the first transmitting device, parsing, by the receiving device, the second protocol data stream to obtain the address of the second transmitting device, and storing the address of the first transmitting device and the address of the second transmitting device in a database;
parsing, by the receiving device, a third protocol data stream from the first transmitting device to obtain the address of the first transmitting device when the receiving device receives the third protocol data stream for requesting the receiving device to establish a connection with the first transmitting device, wherein the third protocol data stream comprises the address of the first transmitting device; and
determining, by the receiving device, whether the address of the first transmitting device exists in the database; upon determining that the address of the first transmitting device exists in the database, establishing, by the receiving device, a connection with the first transmitting device and transmitting, by the receiving device, confirmation information to the first transmitting device, wherein the confirmation information is used for representing that the receiving device has established the connection with the first transmitting device; wherein
establishing, by the receiving device, the connection with the first transmitting device comprises:
switching, by the receiving device, from a communication channel between the receiving device and the transmitting device to a communication channel between the receiving device and the first transmitting device.

9. The receiving of claim 5, wherein the receiving method further comprises:
after decoding, by the receiving device, the specific code stream data with the decompression algorithm to obtain specific multimedia data,
outputting, by the receiving device, the specific multimedia data to a display device coupled with the receiving device, wherein the display device is configured to display the specific multimedia data.

10. The method of claim 5, wherein the receiving device is integrated into the display device, and the receiving method further comprises:
after the decoding, by the receiving device, the specific code stream data with the decompression algorithm to obtain the specific multimedia data,
outputting, by the receiving device, the specific multimedia data to a display module of the display device, wherein the display module is configured to display the specific multimedia data.

11. A transmitting device, comprising:
a first memory and a first processor connected to the first memory, wherein the first memory is configured to store first application program codes, and the first processor is configured to call the first application program codes to perform the following:
obtaining multimedia data;
encoding the multimedia data with a compression algorithm to obtain code stream data, encapsulating the code stream data into a protocol data stream;
modulating the protocol data stream with a first modem, and
transmitting a modulated signal to a receiving device based on a millimeter wave communication technology of a 60 GHz frequency band.

12. The transmitting device of claim 11, wherein the first processor is configured to:
encode the multimedia data with a display stream compression (DSC) algorithm to obtain the code stream data.

13. The transmitting device of claim 11, wherein the first processor is configured to:
when a data format of the multimedia data is a RGB format, convert, through a color space converter (CSC), the multimedia data with RGB format into the multimedia with the YUV444 format, sample the multimedia with the YUV444 format to obtain first data with the YUV format, and encode, through a DSC algorithm, the first data to obtain the code stream data.

14. The transmitting device of claim 11, wherein
the transmitting device is configured to be coupled with a video source device, and the video source device comprises a first video source device and a second video source device;
the transmitting device further comprises an infrared receiving head, wherein the infrared receiving head is configured to receive an infrared analog signal from a remote control;
before the first processor is configured to obtain the multimedia data,
the first processor is further configured to:
demodulate the infrared analog signal to obtain an infrared digital signal;
decode the infrared digital signal to obtain a channel control code;
determine a channel control instruction associated with the channel control code according to the channel control code; and
switch an HDMI channel between the transmitting device and the video source device to an HDMI channel between the transmitting device and the first video source device according to the channel control instruction, wherein the HDMI channel between the transmitting device and the first video source device is configured to obtain the multimedia data from the first video source device for the transmitting device.

15. A receiving device, comprising:
a second memory and a second processor connected to the second memory, wherein the second memory is configured to store second application program codes, and the second processor is configured to call the second application program codes to perform the following:
demodulating, by a second modem, the modulated signal from the transmitting device to obtain a specific protocol data stream; and
decapsulating the specific protocol data stream to obtain specific code stream data, and decoding the specific code stream data with a decompression algorithm to obtain specific multimedia data.

16. The receiving device of claim 15, wherein the second processor configured to decode the specific code stream data with the decompression algorithm to obtain the specific multimedia data is configured to decode the specific code stream data with a display stream compression (DSC) decoding algorithm to obtain the specific multimedia data.

17. The receiving device of claim 15, wherein
the second processor configured to decode the specific code stream data with the decompression algorithm to obtain the specific multimedia data is configured to:
when a format of the specific multimedia data is a RGB format, decode, through the DSC decoding algorithm, the specific stream data to obtain first specific data with a YUV format, interpolating the first specific data to obtain the specific multimedia data with a YUV444 data format, and convert, through a color space converter (CSC), the specific multimedia data with the YUV444 format into the specific multimedia data with the RGB format.

18. The receiving device of claim 15, wherein the transmitting device comprises a first transmitting device and a second transmitting device;
the receiving device further comprises an input interface configured to receive a first protocol data stream from the first transmitting device and a second protocol data stream from the second transmitting device, wherein the first protocol data stream comprises an address of the first transmitting device, and the second protocol data stream comprises an address of the second transmitting device; and
the second processor is further configured to:
parse the first protocol data streams to obtain the address of the first transmitting device, the second protocol data streams to obtain the address of the second transmitting device to obtain the address of the second transmitting device and store the address of the first transmitting device and the address of the second transmitting device in a database;
parse a third protocol data stream for requesting the receiving device to establish a connection with the first transmitting device to obtain an address of the transmitting device when the input interface is further configured to receive the third protocol data stream from the first transmitting device, wherein the third protocol data stream comprises the address of the first transmitting device;
determine whether the address of the first transmitting device exists in the database; and
switch from a communication channel between the receiving device and the transmitting device to a communication channel between the receiving device and the first transmitting device, upon determining that the address of the first transmitting device exists in the database.

19. The receiving device of claim 15, wherein
the receiving device further comprise an output interface; wherein
the output interface is configured to output the specific multimedia data to a display device coupled with the receiving device, and the display device is configured to display the specific multimedia data.

20. The receiving device of claim 15, wherein
the receiving device further comprises an output interface, and the receiving device is integrated into a display device; wherein
the output interface is configured to output the specific multimedia data to a display module of the display device, and the display module is configured to display the specific multimedia data.
